(19) United States
(12) Patent Application Publication
(10) Pub. No.: US 2003/0176619 A1
(43) Pub. Date: Sep. 18, 2003

(54) Polyurethane covered golf balls

(76) Inventors: Viktor Keller, Bradenton, FL (US); Thomas J. Kennedy III, Wilbraham, MA (US); Michael J. Tzivanis, Chicopee, MA (US); William M. Risen JR., Rumford, RI (US)

Correspondence Address: Michelle Bugbee, Esq., Associate Patent Counsel, Spalding Sports Worldwide, Inc., 425 Meadow Street, PO Box 901, Chicopee, MA, 01021-0901, US

(21) Appl. No.: 10/283,522

(22) Filed: Oct. 30, 2002

Related U.S. Application Data
(63) Continuation-in-part of application No. 09/610,416, filed on Jul. 5, 2000.
Application No. 09/610,416 is a continuation-in-part of application No. 09/387,953, filed on Sep. 1, 1999, now Pat. No. 6,287,217.
Application No. 09/387,953 is a division of application No. 09/040,887, filed on Mar. 18, 1998, now Pat. No. 6,083,119.

(51) Int. Cl. C08G 18/30

(52) U.S. Cl. 528/76

(57) ABSTRACT

Disclosed herein is a golf ball comprising a polyurethane component formed by the reaction of an isocyanate, and a polyether polyol comprising homopolymers of ethylene oxide or propylene oxide or copolymers thereof, and a curing agent/chain extender. Another preferred form of the invention is directed to a golf ball cover comprising an isocyanate component and an ethylene/propylene oxide polyether polyol polyurethane component that is formed by reaction injection molding.

### CROSS REFERENCES TO RELATED APPLICATIONS

This application is a continuation-in-part application of U.S. patent application Ser. No. 09/610,416 filed Jul. 5, 2000, which is a continuation-in-part of U.S. patent application Ser. No. 09/387,953 filed Sep. 1, 1999, which is a continuation-in-part of U.S. patent application Ser. No. 09/040,798 filed Mar. 18, 1998.

### FIELD OF THE INVENTION

The present invention relates to golf balls, and more particularly, to improved polyurethane covered golf balls comprising the reaction product of an isocyanate and a polyether polyol consisting of homopolymers of ethylene oxide (EO) or propylene oxide (PO) and/or copolymers thereof.

### BACKGROUND OF THE INVENTION

Golf balls may be classified in generally three types of classes. The first type is a wound ball wherein a vulcanized rubber thread is wound under tension around a solid or semi-solid core, and thereafter enclosed in a single or multi-layer covering of a tough, protective material.

A second type of golf ball is a one-piece ball formed from a solid mass of moldable resilient material that has been cured to develop the necessary degree of hardness. By definition, one-piece molded balls do not have a separate enclosing cover.

A third type of ball is a multi-piece (two or more pieces), non-wound ball, which includes a solid or liquid core and a cover having one or more layers formed over the core. One or more additional layers may optionally be disposed between the core and the cover.

Golf ball covers have been made of, among other materials, ionomers, balata (natural and synthetic and blending thereof), and polyurethanes. When covers are made from conventional polyurethanes and formed by conventional methods, such as by casting, substantial amounts of time and energy are required, thus resulting in relatively high costs. Furthermore, a variety of inefficiencies exist stemming from the use of currently known polyurethanes.

In this regard, golf balls are typically made by molding a core of elastomeric or polymeric material into a spheroid shape. A cover is then molded around the core. Sometimes, before the cover is molded about the core, an intermediate layer is molded about the core and the cover is then molded around the intermediate layer. The molding processes used for the cover and the intermediate layer are similar and usually involve either compression molding or injection molding.

In compression molding, the golf ball core is inserted into a central area of a two-piece die and pre-sized sections of cover material are placed in each half of the die, which then clamps shut. The application of heat and pressure molds the cover material about the core.

Blends of polymeric materials have been used for modern golf ball covers because various grades and combinations have offered certain levels of hardness to resist damage when the ball is hit with a club and elasticity to allow responsiveness to the hit. Some of these materials facilitate processing by compression molding, yet disadvantages have arisen. These disadvantages include the presence of seams in the cover, which occur where the pre-sized sections of cover material were joined, and long process cycle times which are required to heat the cover material and complete the molding process.

Injection molding of golf ball covers arose as a processing technique to overcome some of the disadvantages of compression molding. The process involves inserting a golf ball core into a die, closing the die and forcing a heated, viscous polymeric material into the die. The material is then cooled and the golf ball is removed from the die. Injection molding is well suited for thermoplastic materials, but has limited applications to some thermosetting polymers. However, certain types of these thermosetting polymers often exhibit the hardness and elasticity desired for a golf ball cover. Some of the most promising thermosetting materials are reactive, requiring two or more components to be mixed and rapidly transferred into a die before a polymerization reaction is complete. As a result, traditional injection molding techniques do not provide proper processing when applied to these materials.

Reaction injection molding (RIM) is a processing technique used specifically for certain reactive thermosetting plastics. As mentioned above, by “reactive” it is meant that the polymer is formed from two or more components which react. Generally, the components, prior to reacting, exhibit relatively low viscosities. The low viscosities of the components allow the use of lower temperatures and pressures than those utilized in traditional injection molding. In reaction injection molding, the two or more components are combined and reacted to produce the final polymerized material. Mixing of these separate components is critical, a distinct difference from traditional injection molding.

The process of reaction injection molding a golf ball cover involves placing a golf ball core into a die, closing the die, injecting the reactive components into a mixing chamber where they combine, and transferring the combined material into the die. The mixing begins the polymerization reaction that is typically completed upon cooling of the cover material.

Accordingly, it would be useful to produce a polyurethane that could be used in the production of golf ball components, especially covers, that would provide a wide range of desirable properties (i.e., scuff and cut resistance, playability, feel, etc.). It is further desirable to produce such a polyurethane component via a fast-chemical-reaction like that occurring in a reaction injection molding.

### SUMMARY OF THE INVENTION

An object of the invention is to produce a golf ball having a polyurethane component, such as a polyurethane cover layer. The polyurethane is formed from the reaction of an isocyanate and a polyether polyol comprising homopolymers or copolymers of ethylene oxide (EO) or propylene oxide (PO).

Another object of the invention is to produce a golf ball having a core and a cover, wherein at least the cover includes a polyurethane formed by the reaction of a diisocyanate and a polyether-based polyol comprising homopolymers of ethylene oxide (EO) or propylene oxide (PO), or copolymers thereof.

Yet another object of the invention is to produce a golf ball having a thermoset polyurethane cover comprising the reaction product of at least one diisocyanate, at least one ethylene/propylene oxide (E/PO) polyether polyol and a curing agent. Preferably, the cover is formed by reaction injection molding these compounds.

Still another object of the invention is to produce a golf ball having a polyurethane cover formed by reacting at least one diisocyanate, at least one ethylene/propylene oxide (E/PO) polyether polyol having a molecular weight between 100 and 10,000 and a hydroxy or amine functional chain extender.

A further object of the invention is to produce a polyurethane covered golf ball having an ethylene/propylene oxide (E/PO) polyether-based polyol component, such as polypropylene oxide based polyols, having a molecular weight greater than 100, preferably greater than 1,000. These polyols are reacted with an isocyanate and a curing agent/chain extender to produce a polyurethane cover exhibiting enhanced scuff and cut resistance.

A still further object of the invention is to produce a polyurethane covered golf ball formed by reaction injection molding. The RIM polyurethane comprises an isocyanate compound and an ethylene/propylene oxide (E/PO) polyether polyol/diamine curing agent component.

Another object of the invention is to provide a golf ball comprising a polyurethane material in which the polyurethane material is a reaction product of a diisocyanate, a polyether-based polyol having a molecular weight greater than 1,000 and comprising homopolymers or copolymers of ethylene oxide (EO) or propylene oxide (PO), and a curing agent or chain extender.

Still another object of the invention is to produce a multi-piece golf ball comprising a generally spherical core, one or more optional intermediate layer(s) disposed about the core, and a cover layer disposed about the intermediate layer, in which at least one of the intermediate layer and the cover layer comprises a polyurethane material which is a reaction product of diisocyanate and a polyether polyol having a molecular weight greater than 1,000 and comprising homopolymers or copolymers of ethylene oxide or propylene oxide, and a diamine curing agent or chain extender.

Yet another object of the invention is to provide a golf ball comprising a core and a cover in which the cover includes a polyurethane that is a reaction product of a diisocyanate and a polyether polyol comprising a homopolymer of propylene oxide (PO), such as a polypropylene oxide based polyol, in which the polyol has a molecular weight of from about 100 to 10,000.

Another object of the invention is to provide a golf ball comprising a core and a cover in which the cover includes a polyurethane that is a reaction product of a diisocyanate, a polyether polyol which is a homopolymer of propylene oxide (PO) in which the polyol has a molecular weight of from about 100 to 10,000 and a diamine curing agent. The resulting polyurethane exhibits a Shore D hardness in the range of from about 10 to about 95 and flexural modulus in the range from about 0.1 to about 310 Kpsi.

Another further object of the invention is to provide a thermoset polyurethane covered golf ball formed from the reaction of a diisocyanate, e.g. diphenylmethane diisocyanate (MDI), toluene diisocyanate (TDI), isophorone diisocyanate (IPDI) and the like, with a polyether-based polyol comprising homopolymers or copolymers of ethylene oxide or propylene oxide (E/PO), e.g. polypropylene oxide based polyols and the like, and a chain extender, e.g. an aliphatic diol, such as 1,4 butanediol (BO), or an aromatic diamine, such as diethyl toluene diamine (DETDA). Catalysts can also be included to increase the reactivity. Additional components, such as UV stabilizers, pigments, dyes, processing aids, etc., can be further incorporated in the polyurethane cover material.

A further object of the invention is to provide a polyurethane covered golf ball, comprising a diphenylmethane diisocyanate (MDI), a polypropylene glycol polyether polyol and diethyl toluene diamine (DETDA), wherein the polyurethane is formed by reaction injection molding. The polyol has a number average molecular weight of 100 to 10,000, preferably greater than 1,000.

Still another object of the invention is to provide a polyurethane covered golf ball produced by the reaction of diphenylmethane diisocyanate (MDI) and an ethylene/propylene oxide (E/PO) polyether-based polyol, such as a polyol containing polypropylene glycol, and a curing agent or chain extender. The polyol can be used directly in the reaction mixture or it can be pre-reacted with the diisocyanate to form a prepolymer before the addition of the chain extender or curing agent, or both. The ratio of equivalents of the curing agent/chain extender plus polyol to equivalents of isocyanate is at least about 0.5:1, more preferably about 1:1. The resulting ball exhibits the feel and playability properties of the balata cover ball with enhanced durability (i.e., scuff, shear and/or cut resistance) and/or resilience.

Other objects of the invention will become apparent from the specification and claims.

### DETAILED DESCRIPTION OF THE PREFERRED EMBODIMENTS

The present invention provides a golf ball in which one or more layers of the ball comprises a polyurethane material formed from at least one isocyanate, from at least one polyether polyol consisting of homopolymers of ethylene oxide (EO) or propylene oxide (PO) or copolymers of ethylene oxide and propylene oxide, and at least one curing agent or chain extender. The polyurethane material may be formed by reacting the ethylene/propylene oxide polyether-based polyols with various polyisocyanates and optionally other chain extending diols, triols or amines.

A preferred form of the invention is a golf ball in which at least one cover layer, intermediate mantle layer, or core layer comprises a fast-chemical-reaction-produced component. This component comprises particular polyurethane compositions, and preferably comprises thermosetting polyurethanes.

The invention also includes a method of producing a golf ball which contains a fast-chemical-reaction-produced component. Particularly preferred forms of the invention also provide for a golf ball with a fast-chemical-reaction-produced cover having good scuff and cut resistance.

The method of the invention is particularly useful in forming golf ball components because it can be practiced at relatively low temperatures and pressures. The preferred temperature range for the method of the invention is from about 90 to about 180° F. when the component being produced contains polyurethane. Preferred pressures for practicing the invention using polyurethane-containing materials are 200 psi or less and more preferably 100 psi or less. The method of the present invention offers numerous advantages over conventional slow-reactive process compression molding of golf ball covers. The method results in molded covers in a demold time of 10 minutes or less, preferably 2 minutes or less, and most preferably in 1 minute or less. The method of the present invention results in the formation of a reaction product formed by mixing two or more reactants together, that exhibits a reaction time of about 2 minutes or less, preferably one minute or less, and most preferably about 30 seconds or less. The term fast-chemical-reaction-produced component as used herein refers to such reaction products. An excellent finish can be produced on the ball utilizing these components and molding techniques.

The term “demold time” generally refers to the mold release time, which is the time span from the mixing of the components until the earliest possible removal of the finished part, sometimes referred to in the industry as “green strength.” The term “reaction time” generally refers to the setting time or curing time, which is the time span form the beginning of mixing until a point is reached where the polyaddition product no longer flows. Further description of the terms “setting time” and “mold release time” are provided in the “Polyurethane Handbook,” Edited by Günter Oertel, Second Edition, ISBN 1-56990-157-0, herein incorporated by reference.

As indicated above, the fast-chemical-reaction-produced component can be utilized in one or more cover, mantle, and/or core layers or components of the ball. When a polyurethane cover is formed according to the invention, and then covered with a polyurethane top coat, excellent adhesion can be obtained. The adhesion in this case is better than adhesion of a polyurethane coating to an ionomeric cover. This improved adhesion can result in the use of a thinner top coat, the elimination of a primer coat, and the use of a greater variety of golf ball printing inks beneath the top coat. These include but are not limited to typical inks such as one component polyurethane inks and two component polyurethane inks.

Polyurethanes are polymers which are used to form a broad range of products. They are generally formed by mixing two primary ingredients during processing. For the most commonly used polyurethanes, the two primary ingredients are a polyisocyanate (for example, diphenylmethane diisocyanate monomer (“MDI”) and toluene diisocyanate (“TDI”) and their derivatives) and a polyol (for example, a polyester polyol or a polyether polyol).

A wide range of combinations of polyisocyanates and polyols, as well as other ingredients, are available. Furthermore, the end-use properties of polyurethanes can be controlled by the type of polyurethane utilized, i.e., whether the material is thermoset (cross linked molecular structure) or thermoplastic (linear molecular structure).

Cross linking occurs between the isocyanate groups (—NCO) and the polyol's hydroxyl end-groups (—OH). Additionally, the end-use characteristics of polyurethanes can also be controlled by different types of reactive chemicals and processing parameters. For example, catalysts are utilized to control polymerization rates. Depending upon the processing method, reaction rates can be very quick (as in the case for some reaction injection molding systems (i.e., “RIM”) or may be on the order of several hours or longer (as in several coating systems). Consequently, a great variety of polyurethanes are suitable for different end-users.

Polyurethanes are typically classified as thermosetting or thermoplastic. A polyurethane becomes irreversibly “set” when a polyurethane prepolymer is cross linked with a polyfunctional curing agent, such as a polyamine or a polyol. The prepolymer typically is made from polyether or polyester. Diisocyanate polyethers are preferred because of their water resistance.

The physical properties of thermoset polyurethanes are controlled substantially by the degree of cross linking. Tightly cross linked polyurethanes are fairly rigid and strong. A lower amount of cross linking results in materials that are flexible and resilient. Thermoplastic polyurethanes have some cross linking, but primarily by physical means. The crosslinkings bonds can be reversibly broken by increasing temperature, as occurs during molding or extrusion. In this regard, thermoplastic polyurethanes can be injection molded, and extruded as sheet and blow film. They can be used up to about 350° F. and are available in a wide range of hardnesses.

Golf balls according to the present invention are based, in part, on the discovery of utilizing homopolymers of ethylene oxide (EO) or propylene oxide (PO), or copolymers thereof, as the polyol component in a polyurethane composition in the ball. These polyether polyols lead to golf balls exhibiting superior performance characteristics, i.e., enhanced durability (i.e., scuff and cut resistance) over balata covered golf balls while maintaining or improving corresponding playability and distance characteristics.

The polyether polyols included in the present invention are produced by polymerization of ethylene and/or propylene oxide. These include homopolymers of ethylene oxide or propylene oxide and/or copolymers of the same. The ethylene/propylene oxide polyether polyols have a number average molecular weight of from about 100 to 10,000, preferably greater than 1,000.

Polyurethane materials suitable for the present invention are formed by the reaction of a polyisocyanate, an ethylene/propylene oxide polyether polyol, and optionally one or more chain extenders or curing agents. The chain extenders include, but are not limited, to diols, triols and amine extenders. Any suitable polyisocyanate may be used to form a polyurethane according to the present invention. The polyisocyanate is preferably selected from the group of diisocyanates including, but not limited, to 4,4N-diphenylmethane diisocyanate (“MDI”); 2,4-toluene diisocyanate (“TDI”); m-xylylene diisocyanate (“XDI”); methylene bis-(4-cyclohexyl isocyanate) (“HMDI”); hexamthylene diisocyanate (HDI); naphthalene-1,5,-diisocyanate (“NDI”); 3,3N-dimethyl-4,4N-biphenyl diisocyanate (“TODI”); 1,4-diisocyanate benzene (“PPDI”); phenylene-1,4-diisocyanate; and 2,2,4- or 2,4,4-trimethyl hexamethylene diisocyanate (“TMDI”).

Other less preferred diisocyanates include, but are not limited to, isophorone diisocyanate (“IPDI”); 1,4-cyclohexyl diisocyanate (“CHDI”); diphenylether-4,4N-diisocyanate; p,pN-diphenyl diisocyanate; lysine diisocyanate (“LDI”); 1,3-bis (isocyanato methyl) cyclohexane; and polymethylene polyphenyl isocyanate (“PMDI”).

Suitable glycol chain extenders include, but are not limited to ethylene glycol; propane glycol; butane glycol; pentane glycol; hexane glycol; benzene glycol; xylenene glycol; 1,4-butane diol; 1,3-butane diol; 2,3-dimethyl-2,3-butane diol; and dipropylene glycol.

Suitable amine extenders include, but are not limited to, tetramethyl-ethylenediamine; dimethylbenzylamine; diethylbenzylamine; pentamethyldiethylenetriamine; dimethyl cyclohexylamine; tetramethyl-1,3-butanediamine; 1,2-dimethylimidazole; 2-methylimidazole; pentamethyldipropylenetriamine; and bis-(dismethylaminoethylether).

Polyurethane compositions of the present invention are especially desirable as materials in forming golf balls. Polyurethanes according to the invention, are suitable materials for any of a core layer, a mantle layer, and a cover layer. Most preferably, the polyurethane materials are used to form a cover layer. Accordingly, golf balls according to the present invention, may be formed as two-piece, or multi-layer balls having either a wound core or a solid, non-wound core. In a preferred form, golf balls utilizing a polyurethane composition described herein are solid, i.e., non-wound, multi-layer golf balls comprising a solid non-wound core, a cover formed from the present invention polyurethane, and one or more intermediate layers disposed between the cover and the core.

The golf balls of the present invention can be produced, at least in part, by molding processes currently known in the golf ball art. Specifically, multi-layer golf balls can be produced by injection molding or compression molding a mantle layer about wound or solid molded cores to produce an intermediate golf ball having a diameter of about 1.50 to 1.67 inches, preferably about 1.620 inches. The cover layer is subsequently molded over the mantle layer to produce a golf ball having a diameter of 1.680 inches or more. Although either solid cores or wound cores can be used in the present invention, as a result of their lower cost and superior performance, solid molded cores are preferred over wound cores.

In compression molding, the mantle layer composition is formed via injection at about 380° F. to about 450° F. into smooth surfaced hemispherical shells which are then positioned around the core in a mold having the desired mantle layer thickness and subjected to compression molding at 200° F. to 300° F. for about 2 to 10 minutes, followed by cooling at 50° F. to 70° F. for about 2 to 7 minutes to fuse the shells together to form a unitary intermediate ball. In addition, the intermediate balls may be produced by injection molding wherein the mantle layer is injected directly around the core placed at the center of an intermediate ball mold for a period of time in a mold temperature of from 50° F. to about 100° F. Subsequently, the cover layer is molded about the core and the inner layer by similar compression or injection molding techniques to form a dimpled golf ball of a diameter of 1.680 inches or more.

A preferred method of forming a golf ball according to the present invention is forming one or more layers via a fast-chemical-reaction process. Specifically, the preferred method of forming a fast-chemical-reaction-produced component for a golf ball according to the invention is by reaction injection molding (“RIM”). RIM is a process by which highly reactive liquids are injected into a closed mold, mixed usually by impingement and/or mechanical mixing in an in-line device such as a “peanut mixer,” where they polymerize primarily in the mold to form a coherent, one-piece molded article. The RIM process usually involves a rapid reaction between one or more reactive components such as polyether—or polyester—polyol, polyamine, or other material with an active hydrogen, and one or more isocyanate—containing constituents, often in the presence of a catalyst. The constituents are stored in separate tanks prior to molding and may be first mixed in a mix head upstream of a mold and then injected into the mold. The liquid streams are metered in the desired weight to weight ratio and fed into an impingement mix head, with mixing occurring under high pressure, e.g., 1,500 to 3,000 psi. The liquid streams impinge upon each other in the mixing chamber of the mix head and the mixture is injected into the mold. One of the liquid streams typically contains a catalyst for the reaction. The constituents react rapidly after mixing to gel and form polyurethane polymers. Polyureas, epoxies, and various unsaturated polyesters also can be molded by RIM.

RIM differs from non-reaction injection molding in a number of ways. The main distinction is that in RIM a chemical reaction takes place in the mold to transform a monomer or adducts to polymers and the components are in liquid form. Thus, a RIM mold need not be made to withstand the pressures which occur in a conventional injection molding. In contrast, injection molding is conducted at high molding pressures in the mold cavity by melting a solid resin and conveying it into a mold, with the molten resin often being at about 150 to about 350° C. At this elevated temperature, the viscosity of the molten resin usually is in the range of about 50,000 to about 1,000,000 centipoise, and is typically around 200,000 centipoise. In an injection molding process, the solidification of the resins occurs after about 10 to about 90 seconds, depending upon the size of the molded product, the temperature and heat transfer conditions, and the hardness of the injection molded material. Subsequently, the molded product is removed from the mold. There is no significant chemical reaction taking place in an injection molding process when the thermoplastic resin is introduced into the mold. In contrast, in a RIM process, the chemical reaction causes the material to set in less than about 5 minutes, often in less than 2 minutes, preferably in less than one minute, more preferably in less than 30 seconds, and in many cases in about 10 seconds or less.

If plastic products are produced by combining components that are preformed to some extent, subsequent failure can occur at a location on the cover which is along the seam or parting line of the mold. Failure can occur at this location because this interfacial region is intrinsically different from the remainder of the cover layer and can be weaker or more stressed. By utilizing reaction injection molding techniques, the present invention is believed to provide for improved durability of a golf ball cover layer by providing a uniform or “seamless” cover in which the properties of the cover material in the region along the parting line are generally the same as the properties of the cover material at other locations on the cover, including at the poles. The improvement in durability is believed to be a result of the fact that the reaction mixture is distributed uniformly into a closed mold. This uniform distribution of the injected materials eliminates knit-lines and other molding deficiencies which can be caused by temperature difference and/or reaction difference in the injected materials. The process of the invention results in generally uniform molecular structure, density and stress distribution as compared to conventional injection-molding processes.

The resulting polyurethane component has a flex modulus from about 0.1 to about 310 Kpsi, more preferably from about 5 to about 100 Kpsi, and most preferably from about 5 to about 80 Kpsi. The subject component can be a cover with a flex modulus which is higher than that of the centermost component of the cores, as in a liquid center core and some solid center cores. Furthermore, the polyurethane component can be a cover with a flex modulus that is higher than that of the immediately underlying layer, as in the case of a wound core. The core can be one piece or multi-layer, each layer can be either foamed or unfoamed, and density adjusting fillers, including metals, can be used. The cover of the ball can be harder or softer than any particular core layer.

The polyurethane component can incorporate or be utilized in combination with suitable additives and/or fillers. When the component is an outer cover layer, pigments or dyes, accelerators and UV stabilizers can be added. Examples of suitable optical brighteners which probably can be used include Uvitex and Eastobrite OB-1. An example of a suitable white pigment is titanium dioxide. Examples of suitable and UV light stabilizers are provided in commonly assigned U.S. Pat. No. 5,494,291. Fillers which can be incorporated into the fast-chemical-reaction-produced cover or core component include those listed herein. Furthermore, compatible polymeric materials can be added. For example, when the component comprises polyurethane and/or polyurea, such polymeric materials include polyurethane ionomers, polyamides, etc.

A golf ball inner cover layer formed from a polyurethane material according to the present invention typically contains from about 0 to about 60 weight percent of filler material, more preferably from about 1 to about 30 weight percent, and most preferably from about 1 to about 20 weight percent.

A golf ball outer cover layer formed from a polyurethane material according to the present invention typically contains from about 0 to about 20 weight percent of filler material, more preferably from about 1 to about 10 weight percent, and most preferably from about 1 to about 5 weight percent.

Catalysts can be added to the RIM polyurethane system starting materials as long as the catalysts generally do not react with the constituent with which they are combined. Suitable catalysts include those which are known to be useful with polyurethanes and polyureas.

The reaction mixture viscosity should be sufficiently low to ensure that the empty space in the mold is completely filled. The reactant materials generally are preheated to 90° F. to 150° F. before they are mixed. In most cases it is necessary to preheat the mold to, e.g., 100 to 180° F., to ensure proper injection viscosity.

As indicated above, one or more cover layers of a golf ball can be formed from a polyurethane material according to the present invention.

The polyol component typically contains additives, such as stabilizers, flow modifiers, catalysts, combustion modifiers, blowing agents, fillers, pigments, optical brighteners, and release agents to modify physical characteristics of the cover. Polyurethane/polyurea constituent molecules that were derived from recycled polyurethane can be added in the polyol component.

The golf balls formed according to the present invention can be coated using a conventional two-component spray coating or can be coated during the RIM process, i.e., using an in-mold coating process.

One of the significant advantages of the RIM process according to the invention is that polyurethane or other cover material can be recycled and used in golf ball cores. Recycling can be conducted by, e.g., glycolysis. Typically, 10 to 90% of the material which is injection molded actually becomes part of the cover. The remaining 10 to 90% is recycled.

Golf ball cores also can be made using the materials and processes of the invention. To make a golf ball core using RIM polyurethane, the same processing conditions are used as are described above with respect to covers. Furthermore, an undimpled, smaller mold is used. If, however, a one piece ball is desired, a dimpled mold would be used.

Golf balls typically have indicia and/or logos stamped or formed thereon. Such indicia can be applied by printing using a material or a source of energetic particles after the ball core and/or cover have been reaction-injection-molded according to the present invention. Printed indicia can be formed from a material such as ink, foil (for use in foil transfer), etc. Indicia print using a source of energetic particles or radiation can be applied by burning with a laser, burning with heat, directed electrons, or light, phototransformations of, e.g., UV ink, impingement by particles, impingement by electromagnetic radiation etc. Furthermore, the indicia can be applied in the same manner as an in-mold coating, i.e., by applying to the indicia to the surface of the mold prior to molding of the cover.

The polyurethane which is selected for use as a golf ball cover preferably has a Shore D hardness of from about 10 to about 95, more preferably from about 30 to about 75, and most preferably from about 30 to about 50 for a soft cover layer and from about 50 to about 75 for a hard cover layer. The polyurethane which is to be used for a cover layer preferably has a flex modulus from about 0.1 to about 310 Kpsi, more preferably from about 5 to about 100 Kpsi, and most preferably from about 5 to about 20 Kpsi for a soft cover layer and 30 to 70 Kpsi for a hard cover layer. Accordingly, covers comprising these materials exhibit similar properties.

Non-limiting examples of suitable RIM systems for use in the present invention are Bayflex™ elastomeric polyurethane RIM systems, from Bayer Corp. (Pittsburgh, Pa.). Preferred RIM systems include Bayflex™ MP-10,000, filled and unfilled.

BAYFLEX MP-10,000 is a two component system, consisting of Component A and Component B. Component A comprises the diisocyanate and Component B comprises the polyether polyol plus additional curatives, extenders, etc. The following information is provided by the BAYFLEX MP-10,000 MSDS sheet, regarding the constituent components.

Component A

1. Chemical Product Information (Section 1)

| | |
|---|---|
| Product Name: | BAYFLEX MP-10,000 Component A |
| Chemical Family: | Aromatic Isocyanate Prepolymer |
| Chemical Name: | Diphenylmethane Diisocyanate |
| | (MDI) Prepolymer |
| Synonyms: | Modified Diphenylmethane Diisocyanate |

2. Composition/Information on Ingredients (Section 2)

| Ingredient | Concentration |
|---|---|
| 4,4′-Diphenylmethane Diisocyanate (MDI) | 53-54% |
| Diphenylmethane Diisocyanate (MDI) (2, 2; 2, 4) | 1-10% |

3. Physical and Chemical Properties (Section 9)

| | |
|---|---|
| Molecular Weight: | Average 600-700 |

4. Regulatory Information (Section 15)

| Component | Concentration |
|---|---|
| 4,4′-Diphenylmethane Diisocyanate (MDI) | 53-54% |
| Diphenylmethane Diisocyanate (MDI) (2, 2; 2, 4) | 1-10% |
| Polyurethane Prepolymer | 40-50% |

Component B

1. Chemical Product Information (Section 1)

| | |
|---|---|
| Product Name: | BAYFLEX MP-10,000 Component B |
| Chemical Family: | Polyether Polyol System |
| Chemical Name: | Polyether Polyol containing |
| | Diethyltoluenediamine |

2. Composition/Information on Ingredients (Section 2)

| Ingredient | Concentration |
|---|---|
| Diethyltoluenediamine | 5-15% |

3. Transportation Information (Section 14)

| | |
|---|---|
| Technical Shipping Name: | Polyether Polyol System |
| Freight Class Bulk: | Polypropylene Glycol |
| Freight Class Package: | Polypropylene Glycol |

4. Regulatory Information (Section 15)

| | |
|---|---|
| Diethyltoluenediamine | 5-15% |
| Pigment dispersion | Less than 5% |
| Polyether Polyol | 80-90% |

Additionally, Bayer reports the following further information:

Component A

| Isocyanate: | 4,4 diphenylmethane diisocyanate (MDI) |
|---|---|
| Functionality: | 2.0 |
| Curing Agents: | None |
| Diisocyanate | 60% free MDI; remaining 40% has reacted |
| Concentration: | |
| % NCO: | 22.6 (overall) |
| Equivalent Weight: | 186 |

Component B

| | |
|---|---|
| Polyol: | Trio containing derivatives of polypropylene glycol |
| Functionality: | 3.0 |
| Equivalent Weight: | 2,000 |
| Amine Extender: | Diethyltoluenediamine (equivalent weight of 88) |

The following general properties are produced by this RIM system:

| | | | ASTM Test |
|---|---|---|---|
| Property | Typical Physical Properties | Value | Method |
| General | Specific Gravity | 1.1 | D 792 |
| | Density | 68.7 lb/ft³ | D 1622 |
| | Thickness | 0.118 in | |
| | Shore Hardness | 90 A, 110 D | D 2240 |
| | Mold Shrinkage | 1.42% | (Bayer) |
| | Water Immersion, Length | 0.014 in/in | (Bayer) |
| | Increase | | |
| | Water Absorption: 24 Hours | 3.3% | (Bayer) |
| | Water Absorption: 240 Hours | 5.0% | (Bayer) |
| Mechanical | Tensile Strength, Ultimate | 2,200 lb/in² | D 638/D 412 |
| | Elongation at Break | 300% | D 638/D 412 |
| | Flexural Modulus: 149° F. | 7,900 lb/in² | D 790 |
| | Flexural Modulus: 73° F. | 10,000 lb/in² | D 790 |
| | Flexural Modulus: −22° F. | 23,600 lb/in² | D 790 |
| | Tear Strength, Die C | 240 lbf/in | D 624 |
| Thermal | Coefficient of Linear Thermal | 53 E−06 | D 696 |
| | Expansion | in/in/° F. | |

A wide array of materials may be used for the cores and mantle layer(s) of the present invention golf balls. For instance, the core and mantle or interior layer materials disclosed in U.S. Pat. Nos. 5,833,533; 5,830,087; 5,820,489; and 5,820,488, all of which are hereby incorporated by reference, may be employed. In particular, it is preferred to utilize the cores described in U.S. application Ser. No. 09/226,340, filed Jan. 6, 1999; and Ser. No. 09/226,727, filed Jan. 7, 1999, both of which are hereby incorporated by reference.

In a particularly preferred form of the invention, at least one layer of the golf ball contains at least one part by weight of a filler. Fillers preferably are used to adjust the density, flex modulus, mold release, and/or melt flow index of a layer or component used in the ball. More preferably, at least when the filler is for adjustment of density or flex modulus of a layer, it is present in an amount of at least five parts by weight based upon 100 parts by weight of the layer composition. With some fillers, up to about 200 parts by weight probably can be used.

### Definitions

Unless stated differently, the following parameters are defined and utilized herein as stated below:

Shore D Hardness

As used herein, “Shore D hardness” of a cover is measured generally in accordance with ASTM D-2240, except the measurements are made on a land area of the curved surface of a molded cover, rather than on a plaque. Furthermore, the Shore D hardness of the cover is measured while the cover remains over the core. When a hardness measurement is made on a dimpled cover, Shore D hardness is measured at a land area of the dimpled cover.

### Coefficient of Restitution

The resilience or coefficient of restitution (COR) of a golf ball is the constant “e,” which is the ratio of the relative velocity of an elastic sphere after direct impact to that before impact. As a result, the COR (“e”) can vary from 0 to 1, with 1 being equivalent to a perfectly or completely elastic collision and 0 being equivalent to a perfectly or completely inelastic collision.

COR, along with additional factors such as club head speed, club head mass, ball weight, ball size and density, spin rate, angle of trajectory and surface configuration (i.e., dimple pattern and area of dimple coverage) as well as environmental conditions (e.g., temperature, moisture, atmospheric pressure, wind, etc.) generally determine the distance a ball will travel when hit. Along this line, the distance a golf ball will travel under controlled environmental conditions is a function of the speed and mass of the club and size, density and resilience (COR) of the ball and other factors. The initial velocity of the club, the mass of the club and the angle of the ball's departure are essentially provided by the golfer upon striking. Since club head, club head mass, the angle of trajectory and environmental conditions are not determinants controllable by golf ball producers and the ball size and weight are set by the U.S.G.A., these are not factors of concern among golf ball manufacturers. The factors or determinants of interest with respect to improved distance are generally the coefficient of restitution (COR) and the surface configuration (dimple pattern, ratio of land area to dimple area, etc.) of the ball.

The COR in solid core balls is a function of the composition of the molded core and of the cover. The molded core and/or cover may be comprised of one or more layers such as in multi-layered balls. In balls containing a wound core (i.e., balls comprising a liquid or solid center, elastic windings, and a cover), the coefficient of restitution is a function of not only the composition of the center and cover, but also the composition and tension of the elastomeric windings. As in the solid core balls, the center and cover of a wound core ball may also consist of one or more layers.

The coefficient of restitution is the ratio of the outgoing velocity to the incoming velocity. In the examples of this application, the coefficient of restitution of a golf ball was measured by propelling a ball horizontally at a speed of 125″ 5 feet per second (fps) and corrected to 125 fps against a generally vertical, hard, flat steel plate and measuring the ball's incoming and outgoing velocity electronically. Speeds were measured with a pair of Oehler Mark 55 ballistic screens available from Oehler Research, Inc., P.O. Box 9135, Austin, Tex. 78766, which provide a timing pulse when an object passes through them. The screens were separated by 36″ and are located 25.25″ and 61.25″ from the rebound wall. The ball speed was measured by timing the pulses from screen 1 to screen 2 on the way into the rebound wall (as the average speed of the ball over 36″), and then the exit speed was timed from screen 2 to screen 1 over the same distance. The rebound wall was tilted 2 degrees from a vertical plane to allow the ball to rebound slightly downward in order to miss the edge of the cannon that fired it. The rebound wall is solid steel 2.0 inches thick.

As indicated above, the incoming speed should be 125″5 fps but corrected to 125 fps. The correlation between COR and forward or incoming speed has been studied and a correction has been made over the ″5 fps range so that the COR is reported as if the ball had an incoming speed of exactly 125.0 fps.

The coefficient of restitution must be carefully controlled in all commercial golf balls if the ball is to be within the specifications regulated by the United States Golf Association (U.S.G.A.). As mentioned to some degree above, the U.S.G.A. standards indicate that a “regulation” ball cannot have an initial velocity exceeding 255 feet per second in an atmosphere of 75° F., when tested on a U.S.G.A. machine. Since the coefficient of restitution of a ball is related to the ball's initial velocity, it is highly desirable to produce a ball having sufficiently high coefficient of restitution to closely approach the U.S.G.A. limit on initial velocity, while having an ample degree of softness (i.e., hardness) to produce enhanced playability (i.e., spin, etc.).

### Compression

PGA compression is another important property involved in the performance of a golf ball. The compression of the ball can affect the playability of the ball on striking and the sound or “click” produced. Similarly, compression can affect the “feel” of the ball (i.e., hard or soft responsive feel), particularly in chipping and putting.

Moreover, while compression itself has little bearing on the distance performance of a ball, compression can affect the playability of the ball on striking. The degree of compression of a ball against the club face and the softness of the cover strongly influences the resultant spin rate. Typically, a softer cover will produce a higher spin rate than a harder cover. Additionally, a harder core will produce a higher spin rate than a softer core. This is because at impact a hard core serves to compress the cover of the ball against the face of the club to a much greater degree than a soft core thereby resulting in more “grab” of the ball on the clubface and subsequent higher spin rates. In effect the cover is squeezed between the relatively incompressible core and clubhead. When a softer core is used, the cover is under much less compressive stress than when a harder core is used and therefore does not contact the clubface as intimately. This results in lower spin rates.

The term “compression” utilized in the golf ball trade generally defines the overall deflection that a golf ball undergoes when subjected to a compressive load. For example, PGA compression indicates the amount of change in golf ball's shape upon striking. The development of solid core technology in two-piece balls has allowed for much more precise control of compression in comparison to thread wound three-piece balls. This is because in the manufacture of solid core balls, the amount of deflection or deformation is precisely controlled by the chemical formula used in making the cores. This differs from wound three-piece balls wherein compression is controlled in part by the winding process of the elastic thread. Thus, two-piece and multi-layer solid core balls exhibit much more consistent compression readings than balls having wound cores such as the thread wound three-piece balls.

In the past, PGA compression related to a scale of from 0 to 200 given to a golf ball. The lower the PGA compression value, the softer the feel of the ball upon striking. In practice, tournament quality balls have compression ratings around 70 to 110, preferably around 80 to 100.

In determining PGA compression using the 0 to 200 scale, a standard force is applied to the external surface of the ball. A ball which exhibits no deflection (0.0 inches in deflection) is rated 200 and a ball which deflects 2/10th of an inch (0.2 inches) is rated 0. Every change of 0.001 of an inch in deflection represents a 1 point drop in compression. Consequently, a ball which deflects 0.1 inches (100×0.001 inches) has a PGA compression value of 100 (i.e., 200 to 100) and a ball which deflects 0.110 inches (110×0.001 inches) has a PGA compression of 90 (i.e., 200 to 110).

In order to assist in the determination of compression, several devices have been employed by the industry. For example, PGA compression is determined by an apparatus fashioned in the form of a small press with an upper and lower anvil. The upper anvil is at rest against a 200-pound die spring, and the lower anvil is movable through 0.300 inches by means of a crank mechanism. In its open position the gap between the anvils is 1.780 inches allowing a clearance of 0.100 inches for insertion of the ball. As the lower anvil is raised by the crank, it compresses the ball against the upper anvil, such compression occurring during the last 0.200 inches of stroke of the lower anvil, the ball then loading the upper anvil which in turn loads the spring. The equilibrium point of the upper anvil is measured by a dial micrometer if the anvil is deflected by the ball more than 0.100 inches (less deflection is simply regarded as zero compression) and the reading on the micrometer dial is referred to as the compression of the ball. In practice, tournament quality balls have compression ratings around 80 to 100 which means that the upper anvil was deflected a total of 0.120 to 0.100 inches.

An example to determine PGA compression can be shown by utilizing a golf ball compression tester produced by Atti Engineering Corporation of Newark, N.J. The value obtained by this tester relates to an arbitrary value expressed by a number which may range from 0 to 100, although a value of 200 can be measured as indicated by two revolutions of the dial indicator on the apparatus. The value obtained defines the deflection that a golf ball undergoes when subjected to compressive loading. The Atti test apparatus consists of a lower movable platform and an upper movable spring-loaded anvil. The dial indicator is mounted such that it measures the upward movement of the spring loaded anvil. The golf ball to be tested is placed in the lower platform, which is then raised a fixed distance. The upper portion of the golf ball comes in contact with and exerts a pressure on the spring loaded anvil. Depending upon the distance of the golf ball to be compressed, the upper anvil is forced upward against the spring.

Alternative devices have also been employed to determine compression. For example, Applicant also utilizes a modified Riehle Compression Machine originally produced by Riehle Bros. Testing Machine Company, Phil., PA to evaluate compression of the various components (i.e., cores, mantle cover balls, finished balls, etc.) of the golf balls. The Riehle compression device determines deformation in thousandths of an inch under a load designed to emulate the 200 pound spring constant of the Atti or PGA compression testers. Using such a device, a Riehle compression of 61 corresponds to a deflection under load of 0.061 inches.

Additionally, an approximate relationship between Riehle compression and PGA compression exists for balls of the same size. It has been determined by Applicant that Riehle compression corresponds to PGA compression by the general formula PGA compression=160−Riehle compression. Consequently, 80 Riehle compression corresponds to 80 PGA compression, 70 Riehle compression corresponds to 90 PGA compression, and 60 Riehle compression corresponds to 100 PGA compression.

Furthermore, additional compression devices may also be utilized to monitor golf ball compression so long as the correlation to PGA compression is known. These devices have been designed, such as a Whitney Tester, to correlate or correspond to PGA compression through a set relationship or formula.

### EXAMPLES

The present invention is further illustrated by the following examples in which the parts of the specific ingredients are by weight. It is to be understood that the present invention is not limited to the examples, and various changes and modifications may be made in the invention without departing from the spirit and scope thereof.

### Example 1

A series of trial were conducted in which various preferred embodiment golf ball cores and corresponding mantle layers were produced in accordance with the present invention. These are summarized below in Tables A-F. Tables A-C are for a first batch of cores and mantles, and Tables D-F are for a second batch of cores and mantles.

TABLE A
RIM Center Compound

| | | Specific | Volume | | BATCH |
|---|---|---|---|---|---|
| MATERIAL | PHR | Gravity | (mm) | Volume (%) | WEIGHT (g) |
| BCP-820 | 40.00 | 0.910 | 43.956 | 31.23 | 320.00 |
| Neo Cis 60 | 30.00 | 0.910 | 32.967 | 23.42 | 240.00 |
| Neo Cis 40 | 30.00 | 0.910 | 32.967 | 23.42 | 240.00 |
| ZINC OXIDE | 22.65 | 5.570 | 4.066 | 2.89 | 181.20 |
| Zn Stearate | 16.00 | 1.090 | 14.679 | 10.43 | 128.00 |
| ZDA | 23.00 | 2.100 | 10.952 | 7.78 | 184.00 |
| color-grey | 0.40 | 1.400 | 0.286 | 0.20 | 3.20 |
| Trig. 42-40B | 1.25 | 1.400 | 0.893 | 0.63 | 10.00 |
| TOTALS | 163.30 | 1.1602 | 140.766 | 100.000 | 1306.400 |

NOTES
mold in production dash 4 cavities (for 1.545″ dia cores)
slug weight. = 42.3-43.3 grams
glebar to 1.48″ diameter
target glebarred properties:
size: 1.48″ dia.
weight 32.15 grams
Riehle compression: 115
*once target properties are met, 18 doz. glebarred centers were made.
Compound specific gravity = 1.1601
Batch factor = 8.00
Polymer Volume = 78.07%

TABLE B
Center Glebarred Data

| Size | pole = 1.478″ diameter |
|---|---|
| | off equator = 1.479″ diameter |
| Weight | 32.1 grams |
| Comp. | 45 PGA |
| COR | .7878 |
| Shore D | 45 peak |
| Rebound | 85.5 |

TABLE C
Mantled Data

| Mantle Mtl | Surlyn 8140/6120 @ 50:50 (by |
|---|---|
| | weight) |
| Mantle prep. | Glebar & chlorination dip |
| Mantle size | 1.58″ diameter |
| Weight | 37.9 grams |
| Comp. | 75 PGA |
| Rebound | 84 |
| COR | .8097 |

TABLE D
RIM Center Compound

| | | Specific | Volume | | BATCH |
|---|---|---|---|---|---|
| MATERIAL | PHR | Gravity | (mm) | Volume (%) | WEIGHT (g) |
| BCP-820 | 40.00 | 0.910 | 43.956 | 31.23 | 320.00 |
| Neo Cis 60 | 30.00 | 0.910 | 32.967 | 23.46 | 240.00 |
| Neo Cis 40 | 30.00 | 0.910 | 32.967 | 23.46 | 240.00 |
| ZINC OXIDE | 21.29 | 5.570 | 3.822 | 2.72 | 170.32 |
| Zn Stearate | 16.00 | 1.090 | 14.679 | 10.45 | 128.00 |
| ZDA | 23.00 | 2.100 | 10.952 | 7.79 | 184.00 |
| color-orange | 0.40 | 1.400 | 0.286 | 0.20 | 3.20 |
| Trig. 42-40B | 1.25 | 1.400 | 0.893 | 0.64 | 10.00 |
| TOTALS | 161.94 | 1.1524 | 140.522 | 100.000 | 1295.520 |

Notes
mold in production dash 4 cavities (for 1.545″ dia cores)
slug weight = 42.15-43.15 grams
glebar to 1.51″ diameter
target glebarred properties:
size: 1.51″ dia.
weight: 34.0 grams
Riehle comp.: 115
*once target properties are met, 18 doz. glebarred centers were made.
Compound specific gravity = 1.1524
Batch factor = 8.00
Polymer Vol. = 78.20%

TABLE E
Center Glebarred Data

| Size | pole = 1.511″ diameter |
|---|---|
| | off equator = 1.512″ diameter |
| Weight | 34.0 grams |
| Comp. | 44 PGA |
| COR | .7856 |
| Shore D | 46 peak |
| Rebound | 85.9 |

TABLE F

| Mantled Data | |
|---|---|
| Mantle Mtl | Surlyn 8140/6120 @ 50:50 |
| | (by weight) |
| Mantle prep. | Glebar & chlorination dip |
| Mantled size | 1.61″ diameter |
| Weight | 40 grams |
| Comp. | 73 PGA |
| Rebound | 85 |
| COR | .8103 |
| Shore D | 68 |
| Thickness | 0.050″ |

A series of trials were carried out in which golf balls having RIM polyurethane covers were produced in accordance with the present invention. These are summarized in Table G below:

TABLE G
CENTER, MANTLED CORE, BALL PHYSICAL PROPERTY/SPIN SUMMARY

| | | (PGA) | | | | | (PGA) | | | | |
|---|---|---|---|---|---|---|---|---|---|---|---|
| | | center | center | center | center | center | core | cor | core | core | core |
| group | code | size | weight | comp. | cor | reb | size | weight | comp. | cor | reb. |
| RIM, | O | 1.51 | 34.0 | 42.3 | 0.7856 | 85.9 | 1.61 | 40.0 | 72.5 | 0.8103 | 85.4 |
| .035″ | | | | | | | | | | | |
| cover | | | | | | | | | | | |
| RIM, | G | 1.48 | 32.1 | 44.6 | 0.7878 | 85.5 | 1.58 | 37.9 | 74.7 | 0.8097 | 84.4 |
| .050″ | | | | | | | | | | | |
| cover | | | | | | | | | | | |
| Strata | control | 1.47 | — | — | — | — | 1.57 | — | — | — | — |
| Tour | | | | | | | | | | | |
| Prof. | | | | | | | | | | | |
| 90 | | | | | | | | | | | |

| | | | | | | | | COVER | | | | | | | |
|---|---|---|---|---|---|---|---|---|---|---|---|---|---|---|---|
| | (PGA) | | | | | | | HARDNESS | | | | | | | |
| | | | | | | | | | | ball | Moment | | | | 9 iron |
| | ball | ball | Ball | ball | Ball | ball | | | dura | dimples | of | | scuff | 9 iron | launch |
| | pole | eq. | weight | comp. | cor | reb. | ball | plaque | (2) | (5) | Inertia | cut(.3) | (4) | spin | angle |
| RIM, | 1.6896 | 1.6900 | 45.88 | 79 | 0.7992 | 78.3 | 56.3 | 40.2 | 140 | D343C | 0.4513 | 1 | 3 | 8542 | 27.3 |
| .035″ | | | | | | | | | | | | | | | |
| cover | | | | | | | | | | | | | | | |
| RIM, | 1.6877 | 1.6880 | 45.61 | 80 | 0.7927 | 76.2 | 50.7 | 40.2 | 253 | D343C | 0.4480 | 1 | 3 | 9082 | 27.5 |
| .050″ | | | | | | | | | | | | | | | |
| cover | | | | | | | | | | | | | | | |
| Strata | 1.6839 | 1.6834 | 45.53 | 71 | 0.7877 | 76.7 | 46.6 | 34.3 | — | D263 | 0.4383 | 1.5 | 4 | 9101 | 26.8 |
| Tour | | | | | | | | | | | | | | | |
| Prof. | | | | | | | | | | | | | | | |
| 90 | | | | | | | | | | | | | | | |

NOTES:
center size based on 12 centers (all sizes are in inch units)
center wt. based on 12 centers
center comp. based on 12 centers
center rebound based on 8 centers
center COR based on 6 centers
core size based on 12 cores
core wt. based on 12 cores
core comp. based on 12 cores
core rebound based on 6 cores
core COR based on 12 cores
ball sizes based on 12 balls
ball wt. based on 12 balls
ball comp. based on 12 balls
ball rebound based on 12 balls
ball COR based on 12 balls
(1) hardness measured using Durotronic 2000 system; RIM plaque was 1 piece, 130″ thick (Bayer = s MP 10000); Strata Tour Pro. Plaque was .120″ thick, 2 ply, Part No. BOO361 (gamma = d @ 40 KGYS)
(2) ball durability based on a 4 clear balls each; all balls hit in barrel #5 (new score plate); all failures are cover-to-core adhesion failures; 0 breakdown - 1 @ 80 (pins), 1 @ 80 (random), 1 @ 150 (random), 1 @ 250 (pins); G breakdown - 1 @ 90 (pins), 2 @ 270 (pins), 1 @ 380 (cut in cover) - all groups ambient conditioned at least 2 weeks after molding prior to durability testing
(3) cut based on a ranking of 1 to 6, 1 being the best (full height test)
(4) scuff based on a ranking from 1-6, 1 being the best
(5) cavities were coated with semi-permanent unicore release . . . didn = t release well (approx. 40 shots worth) ball data based on painted balls using TCL epoxy white 6315/6316/6317; Urethane White 6318/6319/6320, both @ 120 gr. Wet with a 16 hr. Dry @ 100−105F in-between; std. Prod. SRC top coat
Moment of Inertia Units are oz$in²;
paint adhesion ok for O & G balls; cracking observed mainly on G balls above were pressure blasted for 10 mins. @ ABS using 150 mesh white alum. oxide; paint cracking slightly less on pressure blasted balls versus brush tumble (adhesion ok on brush tumbled balls as well)

### Example 2

A polybutadiene golf ball core having a diameter of 1.545 inches, a PGA compression of about 65 and a coefficient of restitution of about 0.770 was obtained. A dimpled cover having a thickness of 0.0675 inches was reaction injection molded over the core. The cover comprised Bayflex MP 10000 resin (Bayer). The resulting ball had a PGA compression of 78, a COR of 0.720 and a Shore D cover hardness of 39.

### Example 3

A polybutadiene golf ball center having a diameter of 1.48 inches, a PGA compression of about 45, and a coefficient of restitution (COR) of about 0.788 was obtained. A 0.050 inch thick mantle layer was then injection molded over the center, made from a high acid thermoplastic ionomer material. The mantled core diameter was 1.58 inches, its PGA compression was about 75, and its COR was about 0.810. A dimpled cover having a thickness of about 0.050 inches was reaction injection molded over the mantled core. The cover was comprised of Bayer's Bayflex MP 10000 resin. The setting time of the mixed resin was about 4.5 seconds and the mold release time was about 20 seconds. The isocyanate tank temperature was about 115° F. and the polyol tank temperature was about 138° F. The mold temperature was about 157° F. The resulting ball, after painting, had a pole diameter of about 1.6877 inches, an equator diameter of about 1.6880 inches, a weight of about 45.61 grams, a PGA compression of about 80, a COR of about 0.793, a moment of inertia of about 0.448 oz-in², a drop rebound (based on a 100 inches drop) of about 76 inches, and a Shore D (peak) hardness of about 40 (measured on a 0.130 inch thick plaque of MP 10000).

### Example 4

A polybutadiene golf ball center having a diameter of 1.51 inches, a PGA compression of about 42, and a coefficient of restitution (COR) of about 0.786 was obtained. A 0.050 inch thick mantle layer was then injection molded over the center, made from a high acid thermoplastic ionomer material. The mantled core diameter was 1.61 inches, its PGA compression was about 73, and its COR was about 0.810. A dimpled cover having a thickness of about 0.035 inches was reaction injection molded over the mantled core. The cover was comprised of Bayer's Bayflex MP 10000 resin. The setting time of the mixed resin was about 4.5 seconds and the mold release time was about 20 seconds. The isocyanate tank temperature was about 115° F. and the polyol tank temperature was about 138° F. The mold temperature was about 156° F. The resulting ball, after painting, had a pole diameter of about 1.6896 inches, an equator diameter of about 1.6900 inches, a weight of about 45.68 grams, a PGA compression of about 79, a COR of about 0.799, a moment of inertia of about 0.451 oz-in², a drop rebound (based on a 100 inches drop) of about 78 inches, and a Shore D (peak) hardness of about 40 (measured on a 0.130 inch thick plaque of MP 10000).

### Example 5

A golf ball of the present invention including a cover of Bayer7 MP-10000 polyurethane resin RIM molded at a thickness of 0.035 inches (‘RIM A’) was compared to a ball with a cover also molded at a thickness of 0.035 inches but of conventional ionomer resin (‘Ionomer.’). Also used for comparison were standard balls of the prior art, a Strata Tour7 Professional 90J ball (‘Strata7’) and a Titlelist7 Tour Prestige 90J ball (‘Tour PrestigeJ’). Data based on the comparison is displayed in Table H.

The data for this Example and Example 6 represents the average data for one dozen balls produced according to the prescribed manner. The properties were measured according to the following parameters:

PGA Compression (‘PGA Com.’) generally is a measurement of the deformation of a golf ball from thousandths of an inch determined by a force applied to a spring. The equipment for the measurement is manufactured by Atti Engineering, Union City, N.J. Details of measuring PGA compression are set forth in U.S. Pat. No. 5,779,561, herein incorporated by reference.

Coefficient of restitution (‘COR’) generally is measured by firing the resulting golf ball from an air cannon at a velocity of 125 feet per second against a steel plate which is positioned 12 feet from the muzzle of the cannon. The rebound velocity is then measured. The rebound velocity is divided by the forward velocity to give the coefficient of restitution.

Rebound (‘Rbd.’) generally is measured by dropping a ball from a fixed height of 100 inches and measuring the maximum height reached in inches after the first impact with the ground.

Cover Hardness (‘Cover Hs’) is measured on a Shore C scale using Durotronic 2000J system type C, 10 measurements per ball. Cover hardness is measured by taking the measurement on a land area on the curved surface of the cover layer.

Cut is a ranking from 1 to 6 of the resistance to the ball cover of a cut, 1 being the best. Cut is measured by dropping a 5.9 lb weight from a height of 41″ onto a golf ball in a guillotine fashion, i.e., using a tester set up with a guillotine design. The ball is loosely held in a spherical cavity and the guillotine face strikes the approximate middle of the ball surface. The face of the guillotine is approximately 0.125 inches wide by 1.52 inches long and all edges are radiused in a bullnose fashion. The ball is struck in three different locations and is then assigned a ranking based on the degree of damage.

Scuff is also a ranking from 1 to 6, 1 being the best, using a Maltby7 Sand Wedge to determine the susceptibility of the ball cover to scuffing from the club. A sharp-grooved Maltby7 Sand Wedge with 56 degrees of loft is mounted on the arm of a mechanical swing machine. The sand wedge is swung at 60 miles per hour and hits the ball into a capture net. The ball is hit three times, each time in a different location, and then assigned a ranking based on the degree of damage. The club face of the Maltby7 Sand Wedge has a groove width of 0.025 inches, cut with a mill cutter with no sandblasting or post finishing. Each groove is 0.016 inches deep and the space from one groove edge to the nearest adjacent groove edge is 0.105 inches.

Nine iron spin (‘9 iron spin’), five iron spin (>5 iron spin=) and driver spin are measured by striking the resulting golf balls with a respective club (a nine iron for nine iron spin, a five iron for five iron spin and a driver for driver spin) wherein the club-head speed is about 105 feet per second. The ball is launched at an initial velocity of about 110-115 feet per second at the angle specified in the column designated >9 iron L.A.=for the nine iron spin test, the angle specified in the column designated >5 iron L.A.=for the five iron spin test and the angle specified in the column designation >driver L.A.=for the driver spin test. The spin rate is measured by observing the rotation of the ball in flight using stop action Strobe photography.

TABLE H

| | PGA | | | Cover | | | 9 iron | 9 iron | 5 iron | 5 iron | Driver | Driver |
|---|---|---|---|---|---|---|---|---|---|---|---|---|
| Ball | Com | COR | Rbd. | Hs | Cut | Scuff | spin | L.A. | spin | L.A. | spin | L.A. |
| RIM A | 82.6 | 0.790 | 73.9 | 74.4 | 1 | 3.2 | 9260 | 22.86 | 5233 | 14.67 | 2678 | 9.75 |
| lonomer | 81.8 | 0.795 | 75.3 | 74.2 | 1.5 | — | 9368 | 23.43 | 5149 | 14.64 | 2492 | 9.91 |
| Strata7 | 77.4 | 0.787 | 73.8 | 71.2 | 1.5 | 4 | 9394 | 23.35 | 5253 | 14.68 | 2858 | 9.74 |
| Tour | 72.3 | 0.764 | 68.8 | 76.7 | 2 | 3 | 9629 | 22.78 | 5910 | 14.00 | 3521 | 9.17 |
| PrestigeJ | | | | | | | | | | | | |

As evident in the above data, the golf ball of the present invention exhibits a higher PGA compression than any of the other tested balls, indicating a better response from a club hit. The coefficient of restitution, rebound and spin characteristics of the new ball are better than the Strata7 and Tour PrestigeJ balls. Although the ionomer ball exhibits some properties which are comparable to the ball of the present invention, the cut resistance of the new ball is significantly better. A golf ball of the present invention exhibits a cut resistance of less than 1.5. As a result, the improved properties of the ball of the present invention are evident.

### Example 6

A golf ball of the present invention including a cover of Bayer MP-10000 polyurethane resin RIM molded at a thickness of 0.050 inches (‘RIM B’) was compared to a ball with a cover molded at a thickness of 0.035 inches but of ionomer resin (‘Ionomer’). Also used for comparison are standard balls of the prior art, a Strata Tour7 Professional 90J ball (‘Strata7’) and a Titlelist7 Tour Prestige 90J ball (‘Tour PrestigeJ’). Data based on the comparison is displayed in Table I.

TABLE I

| | PGA | | | Cover | | | 9 iron | 9 iron | 5 iron | 5 iron | Driver | Driver |
|---|---|---|---|---|---|---|---|---|---|---|---|---|
| Ball | Com | COR | Rbd. | Hs | Cut | Scuff | spin | L.A. | spin | L.A. | spin | L.A. |
| RIM B | 83.2 | 0.782 | 72.1 | 71.9 | 1 | 3.2 | 9630 | 22.57 | 5654 | 14.40 | 2799 | 9.20 |
| lonomer | 81.8 | 0.795 | 75.3 | 74.2 | 1.5 | — | 9368 | 23.43 | 5149 | 14.64 | 2492 | 9.91 |
| Strata7 | 77.4 | 0.787 | 73.8 | 71.2 | 1.5 | 4 | 9394 | 23.35 | 5253 | 14.68 | 2858 | 9.74 |
| Tour | 72.3 | 0.764 | 68.8 | 76.7 | 2 | 3 | 9629 | 22.78 | 5910 | 14.00 | 3521 | 9.17 |
| PrestigeJ | | | | | | | | | | | | |

This data illustrates the superior compression and cut resistance of a ball of the present invention, while maintaining levels of other desired properties that are similar to those exhibited by balls of the prior art. As shown in Table I, a golf ball of the present invention exhibits a cut resistance of less than 1.5.

The foregoing description is, at present, considered to be the preferred embodiments of the present invention. However, it is contemplated that various changes and modifications apparent to those skilled in the art, may be made without departing from the present invention. Therefore, the foregoing description is intended to cover all such changes and modifications encompassed within the spirit and scope of the present invention, including all equivalent aspects.

What is claimed:

1. A golf ball comprising a polyurethane material, wherein said polyurethane material is the reaction product of a diisocyanate, a polyether polyol comprising homopolymers of ethylene oxide or propylene oxide or copolymers thereof, and a hydroxy or amine functional chain extender wherein said polyol has a molecular weight of 100 to 10,000.

2. The golf ball of claim 1, wherein said diisocyanate is selected from the group consisting of 4,4N-diphenylmethane diisocyanate; 2,4-toluene diisocyanate; m-xylylene diisocyanate; methylene bis-(4-cyclohexyl isocyanate); hexamethylene diisocyanate; meta-tetramethylxylylene diisocyanate; naphthalene-1,5,-diisocyanate; 3,3N-dimethyl-4,4N-biphenyl diisocyanate; 1,4-diisocyanate benzene; phenylene-1,4-diisocyanate; 2,2,4-trimethyl hexamethylene diisocyanate; 2,4,4-trimethyl hexamethylene diisocyanate; and combinations thereof.

3. The golf ball of claim 1, wherein said polyurethane material has a hardness of from about 10 to about 95 Shore D.

4. The golf ball of claim 3, wherein said polyurethane material has a hardness of from about 30 to about 75 Shore D.

5. The golf ball of claim 1, wherein said polyurethane material has a flex modulus of from about 0.1 to about 310 Kpsi.

6. The golf ball of claim 5, wherein said polyurethane material has a flex modulus of from about 5 to about 100 Kpsi.

7. The golf ball of claim 1, wherein said polyurethane material is formed by a reaction injection molding process.

8. The golf ball according to claim 1, wherein said polyether polyol is a homopolymer of ethylene oxide.

9. The golf ball according to claim 1, wherein said polyether polyol is a homopolymer of propylene oxide.

10. The golf ball according to claim 1, wherein said polyether polyol has a molecular weight greater than 1,000.

11. A golf ball comprising a core and a cover;
wherein at least said cover comprises a polyurethane material formed from the reaction of a diisocyanate, a polyether polyol comprising homopolymers of ethylene oxide or propylene oxide or copolymers thereof, and a hydroxy or amine functional chain extender.

12. The golf ball according to claim 11, wherein at least said cover is formed by a reaction injection molding process.

13. The golf ball according to claim 11, wherein said cover exhibits a flex modulus of from about 0.1 to about 310 Kpsi.

14. The golf ball according to claim 13, wherein said cover exhibits a flex modulus of from about 5 to about 100 Kpsi.

15. The golf ball according to claim 11, wherein said cover exhibits a hardness of from about 10 to about 95 Shore D.

16. The golf ball according to claim 15, wherein said cover exhibits a hardness of from about 30 to about 75 Shore D.

17. The golf ball according to claim 11, wherein said diisocyanate is selected from the group consisting of 4,4N-diphenylmethane diisocyanate; 2,4-toluene diisocyanate; m-xylylene diisocyanate; methylene bis-(4-cyclohexyl isocyanate); hexamethylene diisocyanate; meta-tetramethylxylylene diisocyanate; naphthalene-1,5,-diisocyanate; 3,3N-dimethyl-4,4N-biphenyl diisocyanate; 1,4-diisocyanate benzene; phenylene-1,4-diisocyanate; 2,2,4-trimethyl hexamethylene diisocyanate; 2,4,4-trimethyl hexamethylene diisocyanate; and combinations thereof.

18. The golf ball according to claim 11, wherein said core is selected from the group consisting of a solid core, a multi-layer core, a wound core, a liquid core, a metal filled core, and a foamed core.

19. The golf ball according to claim 11, wherein said polyether polyol has a molecular weight from about 100 to about 10,000.

20. The golf ball according to claim 11, wherein said polyether polyol is a polypropylene oxide based polyol and said chain extender is diethyl toluene diamine.

21. The golf ball according to claim 11, wherein said isocyanate is diphenylmethane diisocyanate.

22. The golf ball according to claim 11 further comprising at least one intermediate layer disposed between said core and said cover.

23. A golf ball comprising a core and a cover, said cover comprising a polyurethane elastomer consisting essentially of the reaction product of:
a. at least one diisocyanaic monomer;
b. at least one polyether polyol having a number average molecular weight greater than 1,000 and selected from the group consisting of homopolymers of ethylene oxide and copolymers of ethylene oxide and propylene oxide, and
c. at least one hydroxy of amino functional chain extenders.

24. The golf ball of claim 23, wherein the chain extender is an aromatic diamine.

25. The golf ball of claim 23 wherein the chain extender is DMTDA.

26. The gold ball of claim 23 wherein the diisocyanate monomer component comprises MDI.

27. The golf ball of claim 23 further comprising at least one antioxidant, UV stabilizer, or light stabilizer to improve color stability.

28. A method of making a golf ball comprising
a. a core, and
b. a cover comprising a polyurethane elastomer, wherein the method comprises molding around a pre-made core a cover composition comprising the reactants necessary to produce said polyurethane elastomer, said reactants consisting essentially of:
i. at least one diisocyanate monomer;
ii. at least one polyether polyol having a number average molecular weight greater than 1,000 and selected from the group consisting of homopolymers of ethylene oxide and copolymers of ethylene oxide and propylene oxide; and,
iii. at least one hydroxy or amine functional chain extender.

29. The method of claim 28 wherein the chain extender is an aromatic diamine.

30. The method of claim 28 wherein the chain extender is DMTDA.

31. The method of claim 28 wherein the diisocyanate monomer component comprises MDI.

32. The method of claim 28 wherein the cover composition further comprises at least one antioxidant, UV stabilizer, or light stabilizer to improve color stability.
